(19) United States
(12) Patent Application Publication
(10) Pub. No.: US 2007/0158024 A1
(43) Pub. Date: Jul. 12, 2007

(54) Methods and systems for removing multiple die(s) from a surface

(75) Inventors: David Addison, Baltimore, MD (US); Travis Steinmetz, New Market, MD (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Symbol Technologies, Inc., Holtsville, NY (US)

(21) Appl. No.: 11/329,134

(22) Filed: Jan. 11, 2006

(51) Int. Cl. B29C 63/00

(52) U.S. Cl. 156/344

(57) ABSTRACT

Methods, systems, and apparatuses for removing dies attached to a support element are described. The support element has a first surface to which the dies are attached and a second surface that opposes the first surface. In a first example, a first vacuum is applied to the second surface outside an area defined on the second surface. At least one force element applies a force to the second surface inside the area, thereby moving a plurality of dies with respect to other dies. In a second example, heat is applied to an adhesive between the first surface and the plurality of dies to at least partially deactivate the adhesive. A second vacuum is applied to the plurality of dies to remove the plurality of dies from the first surface.

### BACKGROUND OF THE INVENTION

1. Field of the Invention

The present invention relates generally to the assembly of electronic devices. More particularly, the present invention relates to the removal of integrated circuit (IC) dies from a surface in high volumes.

2. Related Art

Pick and place techniques are often used to assemble electronic devices. Such techniques involve a manipulator, such as a robot arm, to remove integrated circuit (IC) chips or dies from a wafer and place them into a die carrier. The dies are subsequently mounted onto a substrate with other electronic components, such as antennas, capacitors, resistors, and inductors to form an electronic device.

Conventional pick and place techniques involve complex robotic components and control systems that handle only one die at a time. This has a drawback of limiting throughput volume.

One type of electronic device that may be assembled using pick and place techniques is an RFID “tag.” An RFID tag may be affixed to an item whose presence is to be detected and/or monitored. The presence of an RFID tag, and therefore the presence of the item to which the tag is affixed, may be checked and monitored by devices known as “readers.”

As market demand increases for products such as RFID tags, and as die sizes shrink, high assembly throughput rates and low production costs are crucial in creating commercially viable products. Accordingly, what is needed is a method and apparatus for high volume assembly of electronic devices, such as RFID tags, that overcomes these limitations.

### SUMMARY OF THE INVENTION

The present invention is directed to methods, systems, and apparatuses for producing one or more electronic devices, such as RFID tags, that each include one or more dies. The dies each have one or more electrically conductive contact pads that provide for electrical connections to related electronics on a substrate. In embodiments, dies are transferred to substrates of the electronic devices in parallel, to increase production rates.

According to embodiments of the present invention, electronic devices are formed at greater rates than conventionally possible. In one aspect, large quantities of dies can be removed from a support element. In another aspect, large quantities of dies can be transferred from the support element to an intermediate structure or corresponding substrates of a web of substrates.

Dies are attached to a first surface of a support element. A first vacuum is applied to a second surface of the support element outside an area. For example, the area may be defined by a perimeter of the dies. A force is applied to the second surface inside the area. For example, the force may be applied by at least one actuatable force element. Other means may be used in combination with or in lieu of the first vacuum and/or the force to facilitate removal of the dies. For instance, heat may be applied to an adhesive between the first surface and the dies to at least partially deactivate the adhesive. A second vacuum is applied to the dies to remove the dies from the support element.

These and other advantages and features will become readily apparent in view of the following detailed description of the invention. Note that the Summary and Abstract sections may set forth one or more, but not all exemplary embodiments of the present invention as contemplated by the inventor(s), and thus, are not intended to limit claims.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an exemplary RFID tag, according to an embodiment of the present invention.

FIGS. 2A and 2B show plan and side views of an exemplary die, respectively.

FIGS. 2C and 2D show portions of a substrate with a die attached thereto, according to example embodiments of the present invention.

FIG. 3 is a flowchart illustrating a device assembly process, according to embodiments of the present invention.

FIGS. 4A and 4B are respective plan and side views of a wafer having multiple dies affixed to a support surface.

FIG. 4C shows a die frame attached to a support surface, according to an example embodiment of the present invention.

FIG. 5 is a view of a wafer having separated dies affixed to a support surface.

FIGS. 6A and 6B shows a die removal system, according to an example embodiment of the present invention.

FIGS. 7A and 7B are exemplary front and side views, respectively, of a die removal system, according to an embodiment of the present invention.

FIGS. 8A and 8B are exemplary front and side views, respectively, of a die removal system, according to an embodiment of the present invention.

FIG. 9 is a flowchart of a method for removing dies from a support element, according to an embodiment of the present invention.

The present invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

1.0 Overview

The present invention provides improved processes and systems for assembling electronic devices, including RFID tags. The present invention provides improvements over previous processes. Conventional techniques include systems that pick and place dies one at a time onto substrates. The present invention can remove or transfer multiple dies simultaneously.

Vision-based pick and place systems are limited as far as the size of dies that may be handled, such as being limited to dies larger than 600 square microns (μm²). The present invention is applicable to dies having an area of 100 μm² and even smaller. Furthermore, yield is poor in conventional systems, where two or more dies may be accidentally picked up at a time, causing losses of additional dies.

The present invention provides an advantage of simplicity.

Conventional die transfer tape mechanisms may be used by the present invention. Furthermore, much higher fabrication rates are possible. Previous techniques processed 5-8 thousand units per hour. Embodiments of the present invention enable transfer of dies at rates much faster than this.

Furthermore, because the present invention allows for flip-chip die attachment techniques, wire bonds are not necessary. However, in embodiments, the present invention is also applicable to wire bonded die configurations.

Elements of the embodiments described herein may be combined in any manner. Example RFID tags are described in section 1.1. Assembly embodiments for devices are described in section 1.2. More detailed assembly embodiments for devices are described in sections 2.0 and 3.0.

1.1 Example Electronic Device

The present invention is directed to techniques for producing electronic devices, such as RFID tags. For illustrative purposes, the description herein primarily relates to the production of RFID tags. However, the invention is also adaptable to the production of further electronic device types (e.g., electronic devices including one or more IC dies or other electrical components mounted thereto), as would be understood by persons skilled in the relevant art(s) from the teachings herein. Furthermore, for purposes of illustration, the description herein primarily describes attachment of dies to substrates. However, embodiments of the present invention are also applicable to the attachment of other types of electrical components to substrates, including any type of surface mount component (e.g., surface mount resistors, capacitors, inductors, diodes, etc.), as would be understood by persons skilled in the relevant art(s).

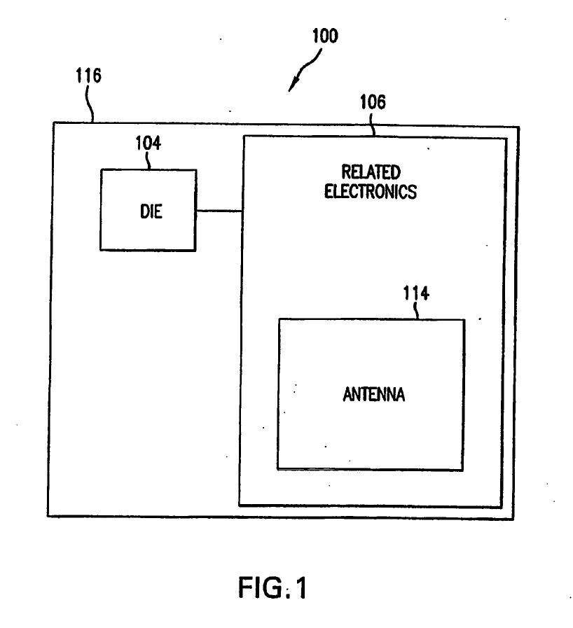

FIG. 1 shows a block diagram of an exemplary RFID tag 100, according to an embodiment of the present invention. As shown in FIG. 1, RFID tag 100 includes a die 104 and related electronics 106 located on a tag substrate 116. Related electronics 106 includes an antenna 114 in the present example. Die 104 can be mounted onto antenna 114 of related electronics 106, or on other locations of substrate 116. As is further described elsewhere herein, die 104 may be mounted in either a pads up or pads down orientation.

RFID tag 100 may be located in an area having a large number, population, or pool of RFID tags present. Tag 100 receives interrogation signals transmitted by one or more tag readers. According to interrogation protocols, tag 100 responds to these signals. The response(s) of tag 100 includes information that the reader can use to identify the corresponding tag 100. Once the tag 100 is identified, the existence of tag 100 within a coverage area defined by the tag reader is ascertained.

RFID tag 100 may be used in various applications, such as inventory control, airport baggage monitoring, as well as security and surveillance applications. Thus, tag 100 can be affixed to items such as airline baggage, retail inventory, warehouse inventory, automobiles, compact discs (CDs), digital video discs (DVDs), video tapes, and other objects. Tag 100 enables location monitoring and real time tracking of such items.

In the present embodiment, die 104 is an integrated circuit that performs RFID operations, such as communicating with one or more tag readers (not shown) according to various interrogation protocols. Exemplary interrogation protocols are described in U.S. Pat. No. 6,002,344 issued Dec. 14, 1999 to Bandy et al., titled “System and Method for Electronic Inventory,” and U.S. patent application Ser. No. 10/072,885, filed on Feb. 12, 2002, both of which are incorporated by reference herein in their entireties. RFID dies of the present invention may communicate according to any RFID communication protocol(s), including binary traversal, slotted Aloha, Class 0, Class 1, Gen 2, and other protocols. Die 104 includes a plurality of contact pads that each provide an electrical connection with related electronics 106.

Related electronics 106 are connected to die 104 through a plurality of contact pads of IC die 104. In embodiments, related electronics 106 provide one or more capabilities, including RF reception and transmission capabilities, impedance matching, sensor functionality, power reception and storage functionality, as well as additional capabilities. Components of related electronics 106 can be mounted or formed on substrate 116 in any manner. For example, components of related electronics 106 can be printed onto a tag substrate 116 with materials, such as conductive inks. Examples of conductive inks include silver conductors 5000, 5021, and 5025, produced by DuPont Electronic Materials of Research Triangle Park, N.C. Other example materials or means suitable for printing related electronics 106 onto tag substrate 116 include polymeric dielectric composition 5018 and carbon-based PTC resistor paste 7282, which are also produced by DuPont Electronic Materials of Research Triangle Park, N.C. Other materials or means that may be used to deposit the component material onto the substrate would be apparent to persons skilled in the relevant art(s) from the teachings herein.

As shown in FIG. 1, tag substrate 116 has a first surface that accommodates die 104, related electronics 106, as well as further components of tag 100. Tag substrate 116 also has a second surface that is opposite the first surface. An adhesive material and/or backing can be included on the second surface. When present, an adhesive backing enables tag 100 to be attached to objects, such as books, containers, and consumer products. Tag substrate 116 is made from a material, such as polyester, paper, plastic, fabrics such as cloth, and/or other materials such as commercially available Tyvec®.

In some implementations of tags 100, tag substrate 116 can include an indentation, “cavity,” or “cell” (not shown in FIG. 1) that accommodates die 104. An example of such an implementation is included in a “pads up” orientation of die 104.

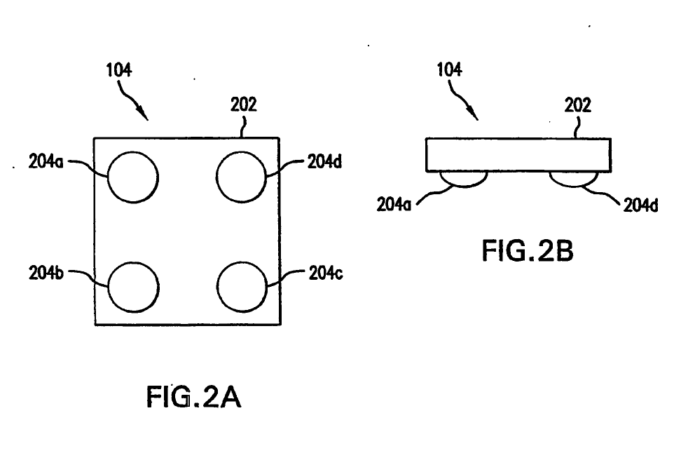

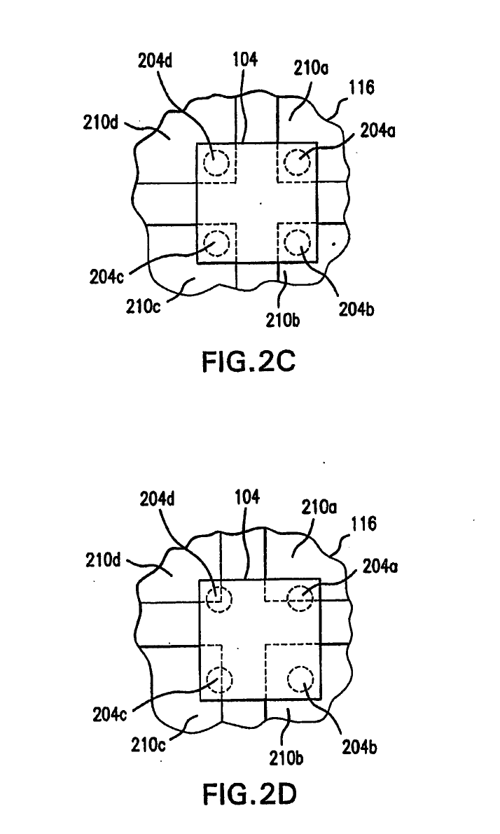

FIGS. 2A and 2B show plan and side views of an example die 104. Die 104 includes four contact pads 204a-d that provide electrical connections between related electronics 106 (not shown) and internal circuitry of die 104. Note that although four contact pads 204a-d are shown, any number of contact pads may be used, depending on a particular application. Contact pads 204 are typically made of an electrically conductive material during fabrication of the die. Contact pads 204 can be further built up if required by the assembly process, by the deposition of additional and/or other materials, such as gold or solder flux. Such post processing, or “bumping,” will be known to persons skilled in the relevant art(s).

FIG. 2C shows a portion of a substrate 116 with die 104 attached thereto, according to an example embodiment of the present invention. As shown in FIG. 2C, contact pads 204a-d of die 104 are coupled to respective contact areas 210a-d of substrate 116. Contact areas 210a-d provide electrical connections to related electronics 106. The arrangement of contact pads 204a-d in a rectangular (e.g., square) shape allows for flexibility in attachment of die 104 to substrate 116, and good mechanical adhesion. This arrangement allows for a range of tolerances for imperfect placement of IC die 104 on substrate 116, while still achieving acceptable electrical coupling between contact pads 204a-d and contact areas 210a-d. For example, FIG. 2D shows an imperfect placement of IC die 104 on substrate 116. However, even though IC die 104 has been improperly placed, acceptable electrical coupling is achieved between contact pads 204a-d and contact areas 210a-d.

Contact pads 204 can be attached to contact areas 210 of substrate 116 using any suitable conventional or other attachment mechanism, including solder, an adhesive material (including isotropic and anisotropic adhesives), mechanical pressure (e.g., being held in place by an encapsulating material), etc.

Note that although FIGS. 2A-2D show the layout of four contact pads 204a-d collectively forming a rectangular shape, a greater or lesser number of contact pads 204 may be used. Furthermore, contact pads 204a-d may be laid out in other shapes in other embodiments.

1.2 Device Assembly

The present invention is directed to continuous-roll assembly techniques and other techniques for assembling electronic devices, such as RFID tag 100. Such techniques involve a continuous web (or roll) of the material of the substrate 116 that is capable of being separated into a plurality of devices. Alternatively, separate sheets of the material can be used as discrete substrate webs that can be separated into a plurality of devices. As described herein, the manufactured one or more devices can then be post processed for individual use. For illustrative purposes, the techniques described herein are made with reference to assembly of tags, such as RFID tag 100. However, these techniques can be applied to other tag implementations and other suitable devices, as would be apparent to persons skilled in the relevant art(s) from the teachings herein.

The present invention advantageously reduces the cycle time of assembling electronic devices, such as RFID tags, by allowing multiple electronic devices to be removed from a surface in parallel, thereby reducing the “pick” time in a pick and place cycle. The present invention is compatible with a continuous-roll technique that is scalable and provides much higher throughput assembly rates than conventional pick and place techniques.

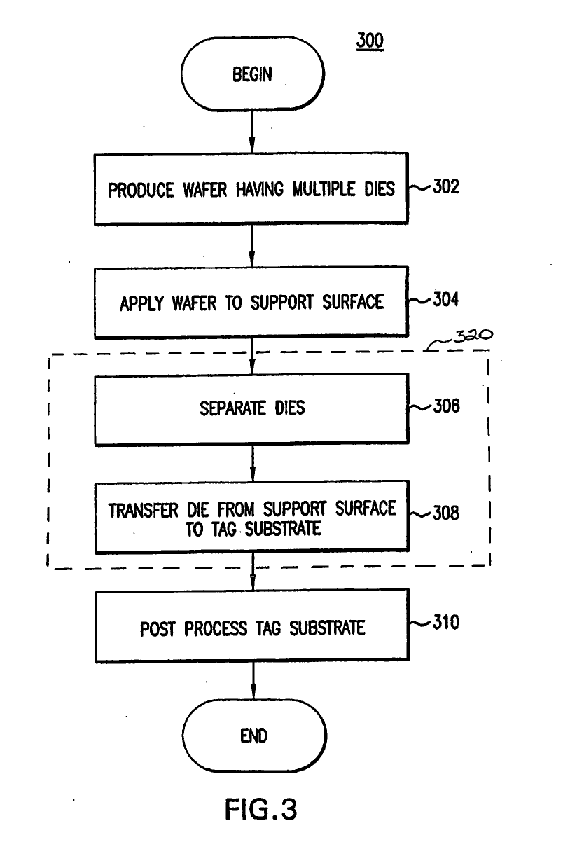

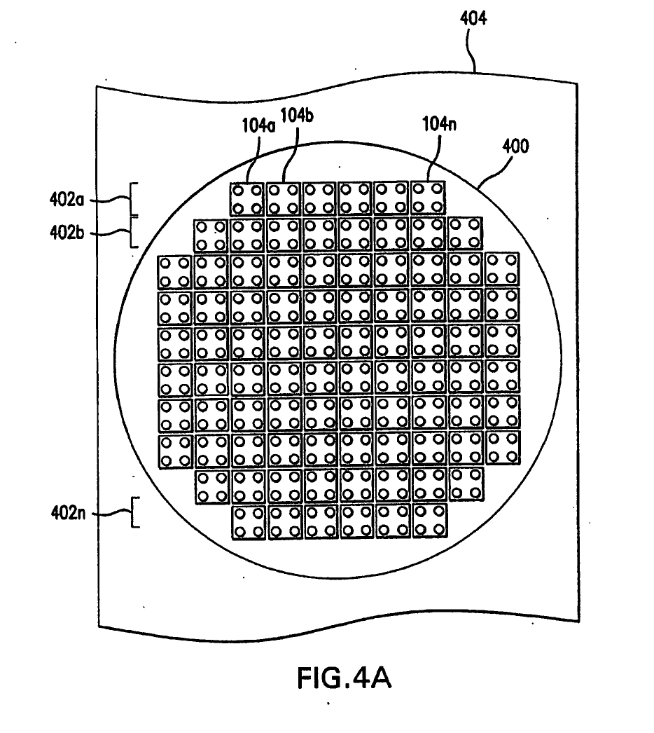

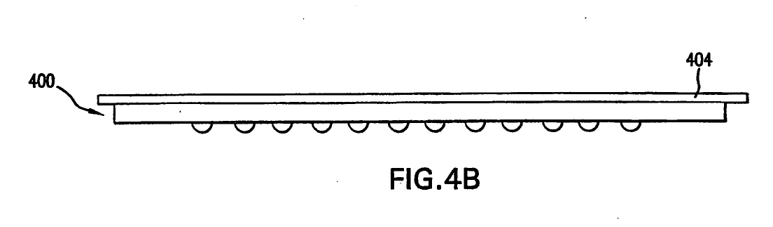

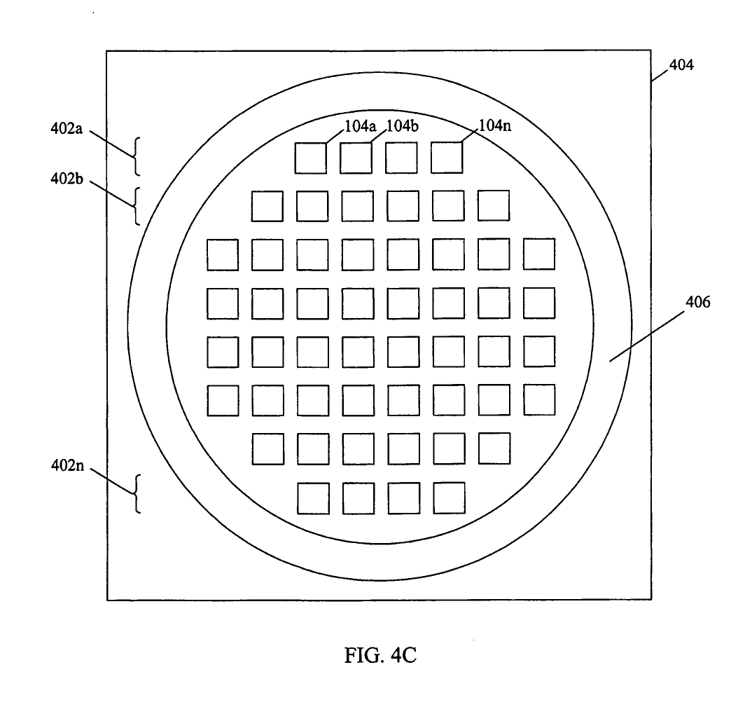

FIG. 3 shows a flowchart 300 with example steps relating to continuous-roll production of RFID tags 100, according to example embodiments of the present invention. FIG. 3 shows a flowchart illustrating a process 300 for assembling tags 100. The process 300 depicted in FIG. 3 is described with continued reference to FIGS. 4A and 4B. However, process 300 is not limited to these embodiments.

Process 300 begins with a step 302. In step 302, a wafer 400 (shown in FIG. 4A) having a plurality of dies 104 is produced. FIG. 4A illustrates a plan view of an exemplary wafer 400. As illustrated in FIG. 4A, a plurality of dies 104a-n are arranged in a plurality of rows 402a-n.

In a step 304, wafer 400 is optionally applied to a support element 404. Support element 404 includes an adhesive material to provide adhesiveness. For example, support element 404 may be an adhesive tape that holds wafer 400 in place for subsequent processing. For instance, in example embodiments, support element 404 can be a “green tape” or “blue tape,” as would be understood by persons skilled in the relevant art(s). Support element 404 may be further processed to enhance/enable removal of dies 104 from support element 404. FIG. 4B shows an example view of wafer 400 in contact with an example support element 404. In some embodiments, wafer 400 is not attached to a support surface, and can be operated on directly.

FIG. 4C shows an example view of a die frame 406 attached to support element 404 to provide structural support for wafer 400 and/or support element 404. An adhesive may be used to attach die frame 406 to support element 404, though the scope of the invention is not limited in this respect. Die frame 406 is shown to be circular for illustrative purposes. Die frame 406 can be any shape, including but not limited to square, rectangular, or elliptical. In an aspect, die frame 406 includes a metal, an alloy, or a combination of metals.

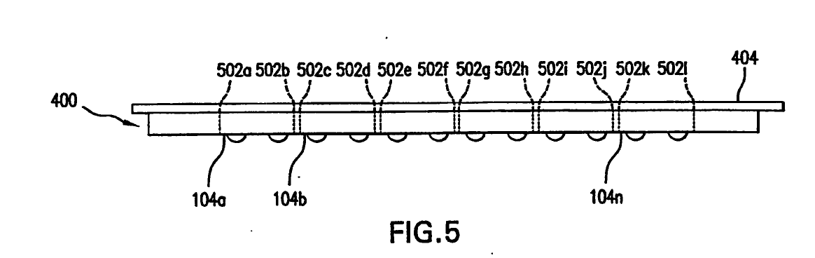

In a step 306, the plurality of dies 104 on wafer 400 are separated or “singulated”. For example, step 306 may include scribing wafer 400 using a wafer saw, laser etching, or other singulation mechanism or process. FIG. 5 shows a view of wafer 400 having example separated dies 104 that are in contact with support element 404. FIG. 5 shows a plurality of scribe lines 502a-1 that indicate locations where dies 104 are separated.

In a step 308, the plurality of dies 104 is transferred to a substrate. For example, dies 104 can be transferred from support element 404 to respective tag substrates 116. Alternatively, dies 104 can be directly transferred from wafer 400 to respective substrates 116. In an embodiment, step 308 may allow for “pads down” transfer. Alternatively, step 308 may allow for “pads up” transfer. As used herein the terms “pads up” and “pads down” denote alternative implementations of tags 100. In particular, these terms designate the orientation of connection pads 204 in relation to tag substrate 116. In a “pads up” orientation for tag 100, die 104 is transferred to tag substrate 116 with pads 204a-204d facing away from tag substrate 116. In a “pads down” orientation for tag 100, die 104 is transferred to tag substrate 116 with pads 204a-204d facing towards, and in contact with tag substrate 116.

Note that step 308 may include multiple die transfer iterations. For example, in step 308, dies 104 may be directly transferred from a wafer 400 to respective substrates 116. Alternatively, dies 104 may be transferred to an intermediate structure, and subsequently transferred to respective substrates 116, such as is as described in U.S. Ser. No. 11/266,208, titled “Method and System for High Volume Transfer of Dies to Substrates,” filed Nov. 4, 2005, which is herein incorporated by reference in its entirety.

Note that steps 306 and 308 can be performed simultaneously in some embodiments. This is indicated in FIG. 3 by step 320, which includes both of steps 306 and 308.

Example embodiments of the steps of flowchart 300, are described in co-pending applications, U.S. Ser. No. 10/866,148, titled “Method and Apparatus for Expanding a Semiconductor Wafer”; U.S. Ser. No. 10/866,150, titled “Method, System, and Apparatus for Transfer of Dies Using a Die Plate Having Die Cavities”; U.S. Ser. No. 10/866,253, titled “Method, System, and Apparatus for Transfer of Dies Using a Die Plate”; U.S. Ser. No. 10/866,159, titled “Method, System, and Apparatus for Transfer of Dies Using a Pin Plate”; and U.S. Ser. No. 10/866,149, titled “Method, System, and Apparatus for High Volume Transfer of Dies,” each of which is herein incorporated by reference in its entirety.

In a step 310, post processing is performed. For example, during step 310, assembly of RFID tag(s) 100 is completed. Example post processing of tags that can occur during step 310 are provided as follows:

(a) Separating or singulating tag substrates 116 from the web or sheet of substrates into individual tags or “tag inlays.” A “tag inlay” or “inlay” is used generally to refer to an assembled RFID device that generally includes an integrated circuit chip and antenna formed on a substrate.

(b) Forming tag “labels.” A “label” is used generally to refer to an inlay that has been attached to a pressure sensitive adhesive (PSA) construction, or laminated and then cut and stacked for application through in-mould, wet glue or heat seal application processes, for example. A variety of label types are contemplated by the present invention. In an embodiment, a label includes an inlay attached to a release liner by pressure sensitive adhesive. The release liner may be coated with a low-to-non-stick material, such as silicone, so that it adheres to the pressure sensitive adhesive, but may be easily removed (e.g., by peeling away). After removing the release liner, the label may be attached to a surface of an object, or placed in the object, adhering to the object by the pressure sensitive adhesive. In an embodiment, a label may include a “face sheet”, which is a layer of paper, a lamination, and/or other material, attached to a surface of the inlay opposite the surface to which the pressure sensitive material attaches. The face sheet may have variable information printed thereon, including product identification regarding the object to which the label is attached, etc.

(c) Testing of the features and/or functionality of the tags.

An intermediate/transfer surface or a final substrate surface may or may not have cells formed therein for dies to reside therein. Various processes described below may be used to transfer multiple dies simultaneously between first and second surfaces, as in step 308, according to embodiments of the present invention. In any of the processes described herein, dies may be transferred in either pads-up or pads-down orientations from one surface to another.

Elements of the die removal/transfer processes described herein may be combined in any way, as would be understood by persons skilled in the relevant art(s). Example die removal/transfer processes, and related example structures for performing these processes, are further described in the following subsections.

2.0 Die Removal/Transfer Embodiments

In this section, example embodiments are described for transferring dies, including removing dies from a surface, such as a surface of a wafer. These embodiments are described for illustrative purposes, and are not limiting. Further embodiments, including modifications, alterations, combinations, etc., will be apparent to persons skilled in the relevant art(s) from the teachings herein. These further embodiments are also within the scope and spirit of the invention.

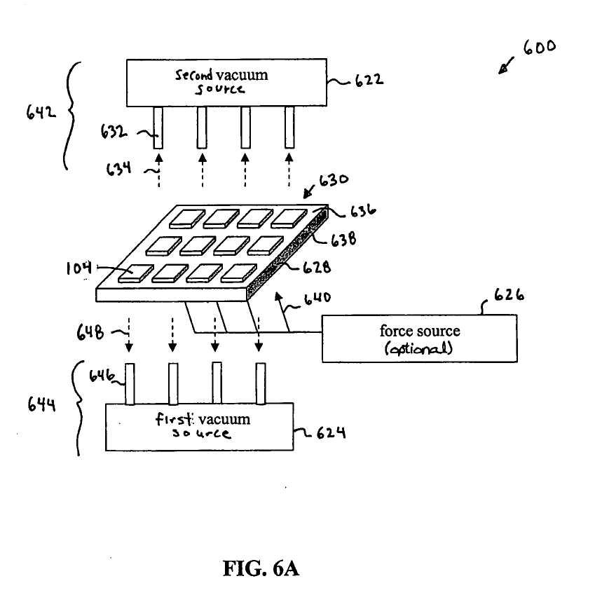

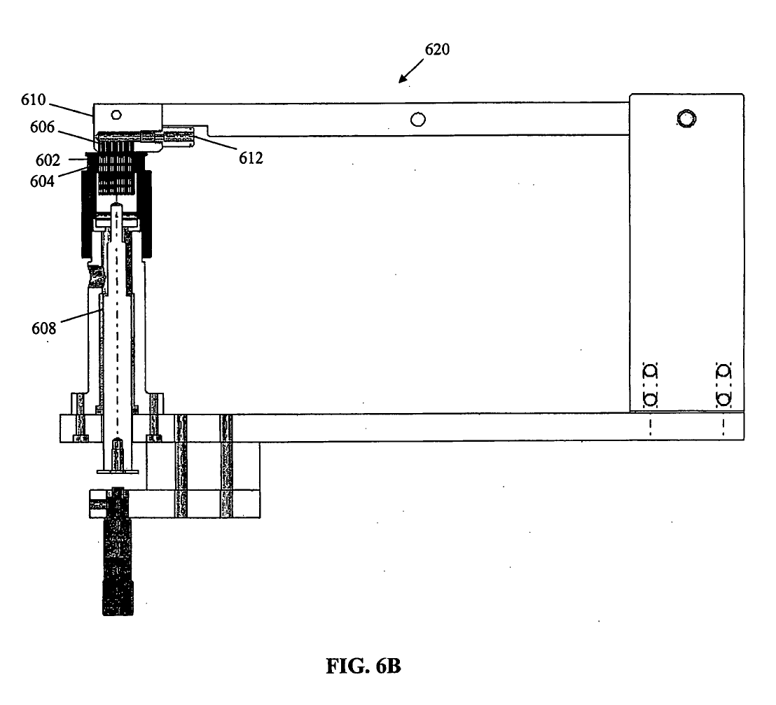

FIG. 6A shows a block diagram of a die removal system 600, according to an example embodiment of the present invention. System 600 may be used to move dies from a first surface. Furthermore, system 600 may be used to transfer dies from the first surface to a second surface.

As shown in FIG. 6A, die removal system 600 includes a die release assembly 644, a vacuum assembly 642, and an optional force source 626. System 600 operates on a support element 628, which attaches an array 630 of dies 104 on a first surface 636 of support element 628. Support element 628 may be any type of adhesive structure that attaches dies, including an adhesive tape, a die support structure described elsewhere herein, or a die support structure otherwise known. Array 630 of dies 104 may be dies of a wafer that was singulated on support element 628, or may be dies positioned on support element 628 in any other manner or arrangement.

Referring to FIG. 6A, when present, force source 626 is configured to apply a force 640 to a second surface 638 of support element 628. Force 640 is applied in an area defined on second surface 638 that is opposite a plurality of dies 104 of array 630 desired to be removed from support element 628. For example, it may be desired to move one or more rows of dies 104 from support element 628 simultaneously. Force source 626 applies a force to second surface 638, opposite dies 104 to be removed, to aid in their removal. Thus, force source 626 may include one or more force elements to move dies 104. A force element may be a pin, a blade, or a bar, to provide some examples. In an aspect, a pin corresponds with a die. In another aspect, a blade corresponds with a row of dies. The blade may be an elongated object having an edge that is applied to support element 628 to move the dies 104. In yet another aspect, a bar corresponds with a plurality of rows of dies. The bar may be an elongated object having a flat surface applied to support element 628 to move the dies 104. A force element may be made from any suitable material, including a metal, a plastic, a polymer, etc.

Force source 626 may include any combination of pin(s), blade(s), bar(s), and/or any other type of force element. The applicable force source element is applied (e.g., mechanically) to second surface 638 to create force 640 to move the die(s), row of dies, or multiple rows of dies, accordingly. Force 640 moves the plurality of dies 104 toward second vacuum source 622.

Furthermore, in an embodiment, force 640 can reduce an adhesion of dies 104 to first surface 636 of support element 628. For example, a force element, such as a pin, may be applied to second surface 638 at a point opposite a central location of a die 104. By applying force 640 to the central location of die 104, the periphery of die 104 may peel away from support element 628, to reduce an adhesion of die 104 to first surface 636.

In the embodiment of FIG. 6A, die release assembly 644 includes a first vacuum source 624 and a plurality of associated vacuum nozzles or openings 646. Die release assembly 644 need not necessarily include a plurality of nozzles or openings 646. In an alternative embodiment, die release assembly 644 includes a single nozzle or opening. First vacuum source 624 supplies a first vacuum 648 to second surface 638 of support element 628. First vacuum 648 is applied outside the area defined on second surface 638 opposite the plurality of dies 104 desired to be removed from support element 628. Thus, first vacuum 648 holds/maintains dies 104 on support element 628 that are not desired to be moved from support element 628.

The area defined on second surface 638 of support element 628 for die removal may be defined to have any shape or size. In an embodiment, the area is defined by a perimeter of dies 104 desired to be removed. However, the scope of the present invention is not limited to this example embodiment. The area defined on second surface 638 may have a shape different from the perimeter of dies 104 desired to be removed. The area may be smaller or larger than the perimeter of dies 104 desired to be removed. For example, first vacuum 648 may be applied partially or entirely inside an area defined by the perimeter of dies 104 desired to be removed. In this example, first vacuum 648 may facilitate peeling of dies 104 that are desired to be removed from first surface 636 of support element 628.

Die release assembly 644 may include other means in combination with or in lieu of first vacuum source 624 and/or force source 626 for releasing the plurality of dies 104 from first surface 636. For example, die release assembly 644 may include a heating element to heat an adhesive between first surface 636 and the plurality of dies 104, thereby reducing adhesion between first surface 636 and the plurality of dies 104. In this example, increasing the temperature of the adhesive partially or wholly deactivates the adhesive. In a first aspect, the heating element is a thermally conductive material that radiates heat. In a second aspect, the heating element conducts or transfers heat from a heating source to the adhesive.

In the embodiment of FIG. 6A, vacuum assembly 642 includes a second vacuum source 622 and a plurality of associated vacuum nozzles or openings 632. Vacuum assembly 642 need not necessarily include a plurality of vacuum nozzles or openings 632. In an alternative embodiment, vacuum assembly 642 includes a single nozzle or opening. Second vacuum source 622 supplies a second vacuum 634 through openings 632 to corresponding dies 104 of array 630 to be removed from support element 628 (i.e., the dies being moved by force source 626 in FIG. 6A). Thus, second vacuum 634 removes the selected dies 104 from first surface 636 of support element 628.

FIG. 6B shows a die removal apparatus 620 that can be used to implement die removal system 600 of FIG. 6A, according to an example embodiment of the present invention. As shown in FIG. 6B, die removal apparatus 620 includes a vacuum head 610, a vacuum hold element 602, a plurality of force elements 604, and an actuator 608.

As shown in FIG. 6B, vacuum hold element 602 provides a first vacuum at an interface between vacuum head 610 and vacuum hold element 602. Vacuum head 610 has openings 606 through which a second vacuum is applied. A vacuum shaft 612 is an open conduit that passes through vacuum head 610 to openings 606. Vacuum shaft 612 allows the second vacuum to be received at openings 606 from a vacuum source (not shown in FIG. 6B). A support element (not shown in FIG. 6B) attaching dies, such as in wafer form, is positioned between vacuum hold element 602 and vacuum head 610.

Vacuum hold element 602 laterally surrounds force elements 604. Actuator 608 actuates force elements 604, thereby moving force elements 604 toward vacuum head 610. Vacuum head 610, vacuum hold element 602, and actuator 608 enable die removal apparatus 620 to remove dies from the support element. Force elements 604 push dies from the support element toward vacuum head 610. Vacuum hold element 602 holds dies to the support element surrounding the dies to be removed.

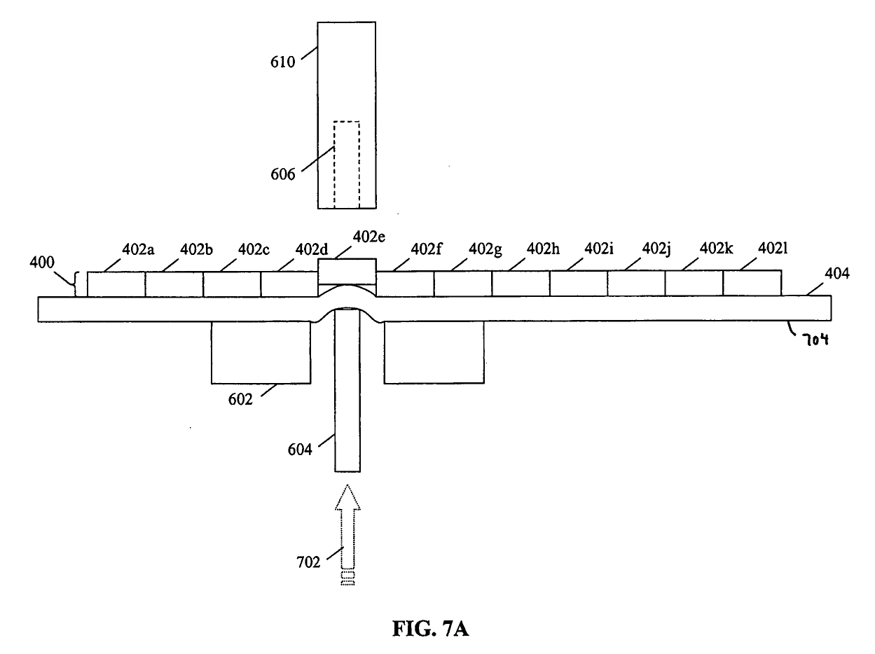

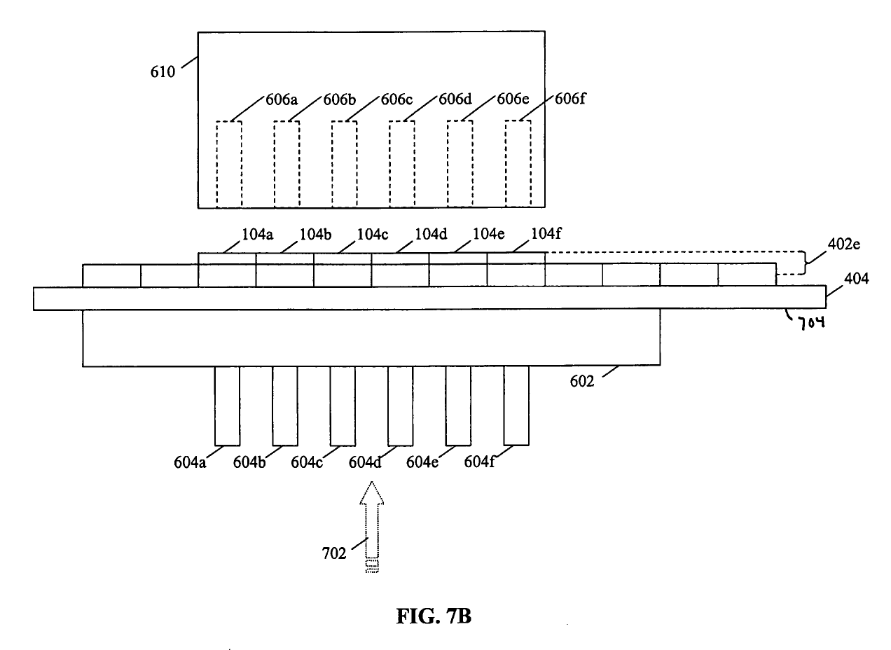

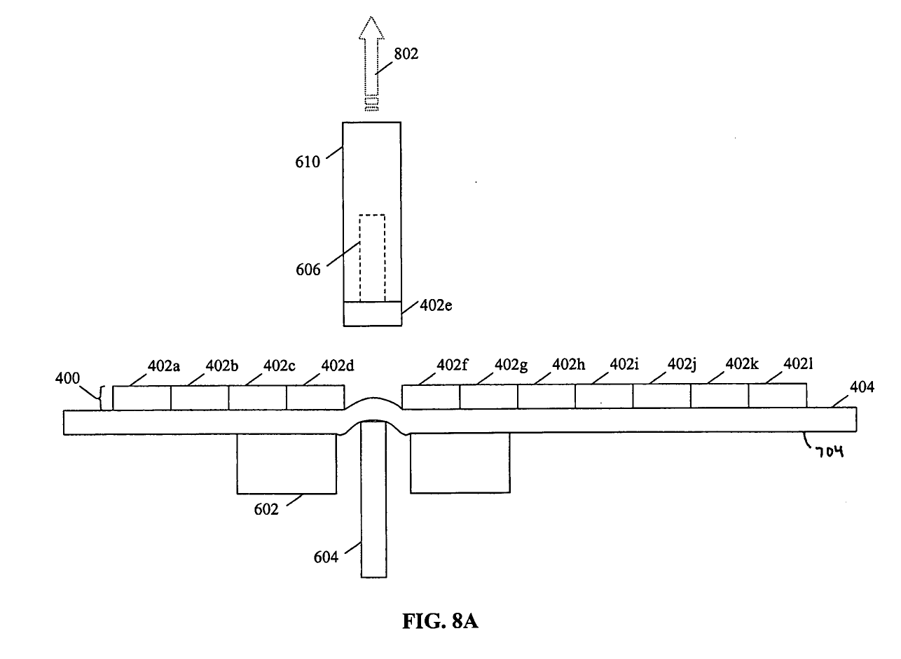

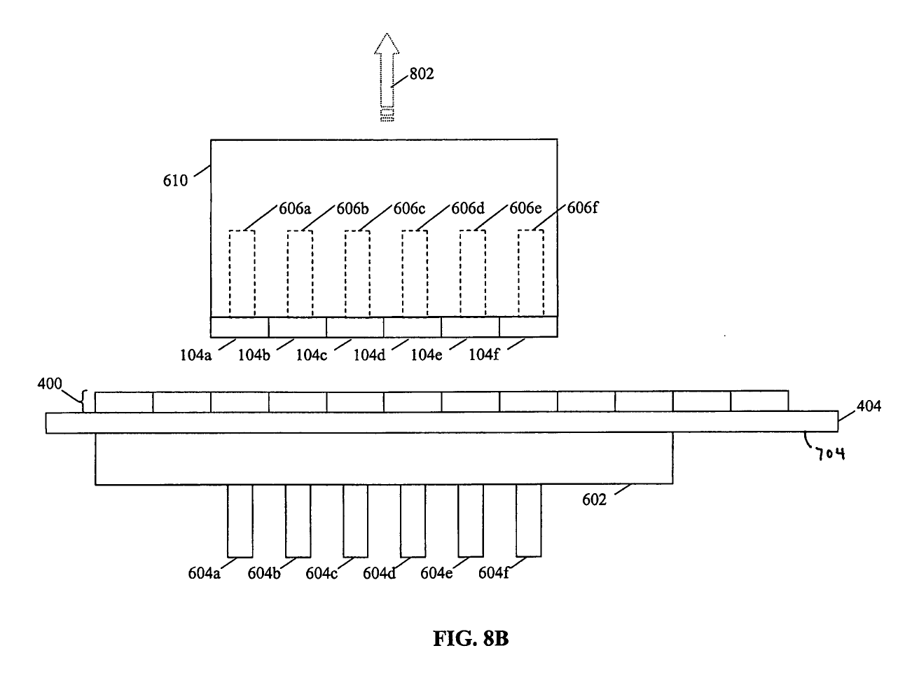

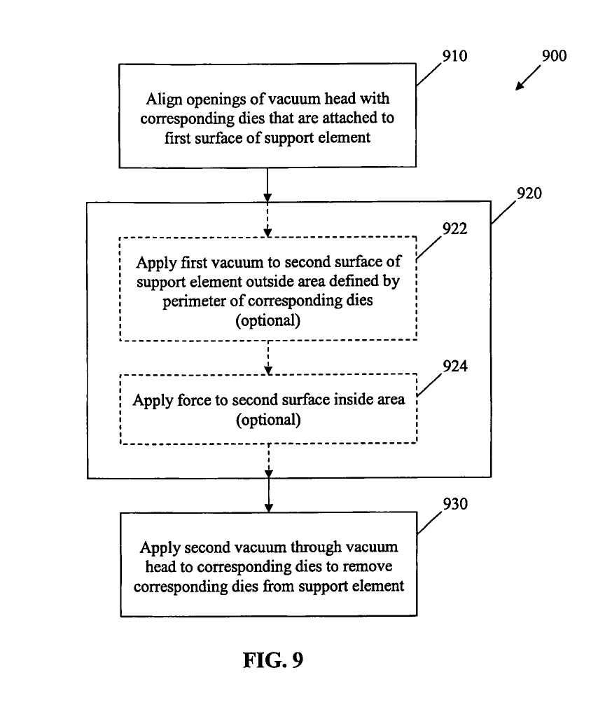

FIGS. 7A, 7B, 8A, and 8B show further details of die removal apparatus 620 during operation. FIG. 9 shows a flowchart 900 for removing dies from a support element, according to an embodiment of the present invention. For example, the steps of flowchart 900 may be performed by die removal apparatus 620. Further structural and operational embodiments of the present invention will be apparent to persons skilled in the relevant art(s) based on the following discussion. The steps of flowchart 900 do not necessary have to occur in the order shown. These steps are described in detail below with respect to FIGS. 7A, 7B, 8A, and 8B.

Flowchart 900 begins with step 910. In step 910, a plurality of openings of a vacuum head are aligned with a plurality of corresponding dies that are attached to a first surface of a support element. For example, FIGS. 7A and 7B respectively show front and side views of die removal apparatus 620. As shown in FIG. 7B, a plurality of openings 606a-606f of vacuum head 610 are aligned with dies 104a-104f of a row 402e on support element 404. Note that six openings 606 are shown for illustrative purposes, and in embodiments, any number of openings 606 may be present, depending on the particular application and the number of dies to be simultaneously transferred.

In step 920, adhesion between the first surface of the support element and the corresponding dies is reduced. The adhesion may be reduced in any of a variety of ways. Steps 922 and 924 illustrate one example way in which the adhesion may reduced.

In step 922, a first vacuum is applied to the second surface of the support element outside an area defined by a perimeter of the corresponding dies. For example, the first vacuum is applied by vacuum hold element 602. In the example of FIGS. 7A and 7B, the first vacuum is applied to a bottom surface 704 of support element 404, outside an area opposite of dies 104a-104f. Thus, dies in rows other than row 402e, such as rows 402d and 402f, are maintained in contact with support element 404, in a relatively planar configuration, by the first vacuum.

In step 924, a force is applied to the second surface inside the area, thereby moving the corresponding dies toward the vacuum head. For example, the force is force 702, applied by plurality of force elements 604 to bottom surface 704 of support element 404. Force 702 is applied by force elements 604 to dies 104a-104f through support element 404. As shown in FIGS. 7A and 7B, dies 104a-104f are moved upward with respect to other rows of dies on support element 404, toward vacuum head 610. Furthermore, an adhesion of die 402e to support element 404 is reduced. By applying force 702 to bottom surface 704 opposite the central location of die 402e, the periphery of die 402e peels away from support element 404, to reduce an adhesion of die 104 to the top surface of support element 404.

In step 930, a second vacuum is applied through the vacuum head to remove the corresponding dies from the support element. For example, as shown in FIGS. 8A and 8B, vacuum head 610 has contacted dies 104a-104f, and a second vacuum is applied through respective openings 606a-606f. Due to the second vacuum, dies 104a-104f attach to vacuum head 610. Vacuum head 610 can then move, such as in the direction of arrow 802, to remove dies 104a-104f from support element 404.

After dies have been moved according to embodiments of the present invention, the dies may be placed on a subsequent surface, such as a substrate, and further assembly and/or other steps can be performed, including processing described above with respect to step 310 of FIG. 3.

3.0 Other Embodiments

FIGS. 1-9 are conceptual illustrations providing a description of transferring/removing dies from a surface, according to embodiments of the present invention. It should be understood that embodiments of the present invention can be implemented in hardware, firmware, software, or a combination thereof. In such an embodiment, the various components and steps are implemented in hardware, firmware, and/or software to perform the functions of the present invention. That is, the same piece of hardware, firmware, or module of software can perform one or more of the illustrated blocks (i.e., components or steps).

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention are implemented using software, the software may be stored in a computer program product and loaded into computer system using a removable storage drive, hard drive, or communications interface. The control logic (software), when executed by a processor, causes the processor to perform the functions of the invention as described herein.

According to an embodiment, a computer executes computer-readable instructions to control the removal of dies from an element, such as support element 404. The computer controls vacuum(s) and/or force(s) that are applied to the element and/or the dies to facilitate the removal of the dies from the element. In an aspect, the computer controls the transfer of the dies from the element to a substrate. For instance, a roll of substrate material may be provided. The computer controls vacuum(s) and/or force(s) that are applied to the element and/or a first group of the dies to transfer the first group from the element to a first portion of the substrate. The roll of substrate may be advanced to provide a second portion of the substrate. The computer controls vacuum(s) and/or force(s) that are applied to the element and/or a second group of the dies to transfer the second group from the element to the second portion of the substrate, and so on. For example, the computer may align a vacuum source, such as vacuum head 610, with successive groups of the dies that are attached to the element to consecutively remove or transfer the successive groups of dies from the element.

In another embodiment, aspects of the present invention are implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

4.0 Conclusion

While various embodiments of the present invention have been described above, it should be understood that they have been presented by way of example, and not limitation. It will be apparent to persons skilled in the relevant arts that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method comprising:
aligning at least one opening of a vacuum head with a plurality of corresponding dies that are attached to a surface;
reducing adhesion between the corresponding dies and the surface; and
applying a vacuum through the vacuum head to remove the corresponding dies from the surface.

2. The method of claim 1, wherein reducing adhesion includes applying heat to an adhesive between the corresponding dies and the first surface.

3. The method of claim 1, wherein reducing the adhesion includes warping the surface, thereby at least partially peeling the corresponding dies from the surface.

4. The method of claim 3, wherein warping the surface moves the corresponding dies a predetermined distance.

5. An apparatus comprising:
means for reducing adhesion between a plurality of dies and a surface; and
a vacuum assembly having at least one opening that is configured to apply a first vacuum concurrently to the plurality of dies to remove the plurality of dies from the surface.

6. The apparatus of claim 5, wherein the means for reducing adhesion includes a heating element to heat an adhesive between the plurality of dies and the surface.

7. The apparatus of claim 5, wherein the means for reducing adhesion includes a force source to at least partially peel the plurality of dies from the surface.

8. The apparatus of claim 5, wherein the plurality of dies are arranged in a row.

9. A method comprising:
aligning at least one opening of a vacuum head with a plurality of corresponding dies that are attached to a first surface of a support element, wherein the support element further has a second surface that is opposite the first surface;
applying a first vacuum to the second surface of the support element outside an area;
applying a force to the second surface inside the area, thereby moving the corresponding dies toward the vacuum head; and
applying a second vacuum through the vacuum head to remove the corresponding dies from the support element.

10. The method of claim 9, wherein applying the first vacuum includes applying the vacuum outside the area defined by a perimeter of the corresponding dies

11. The method of claim 9, wherein applying the force includes actuating at least one force element associated with the corresponding dies, thereby causing the at least one force element to come into contact with the area of the second surface.

12. The method of claim 9, wherein applying the force moves the corresponding dies a predetermined distance.

13. The method of claim 9, wherein applying the first vacuum includes maintaining dies attached to the support element that are outside the area.

14. The method of claim 9, wherein applying the force causes at least partial peeling of the corresponding dies from the first surface.

15. The method of claim 9, wherein aligning the at least one opening includes aligning the at least one opening with the plurality of corresponding dies that are arranged in a row.

16. A method of removing a plurality of dies from an array of dies that are attached to a first surface of a support element, the support element having a second surface that opposes the first surface, comprising:
applying a first vacuum to the second surface outside an area corresponding to a perimeter of the plurality of dies;
applying a force to the second surface inside the area, thereby moving the plurality of dies with respect to other dies of the array of dies; and
applying a second vacuum to the plurality of dies to remove the plurality of dies from the first surface.

17. The method of claim 16, wherein applying the force includes actuating at least one force element associated with the plurality of dies, thereby causing the at least one force element to come into contact with the area of the second surface.

18. The method of claim 16, wherein applying the force moves the plurality of dies a predetermined distance.

19. The method of claim 16, wherein applying the first vacuum includes maintaining attached to the support element dies of the array of dies that are outside the area.

20. The method of claim 16, wherein applying the force causes at least partial peeling of the plurality of dies from the first surface.

21. The method of claim 16, wherein applying the second vacuum includes removing a row of dies from the first surface.

22. An apparatus comprising:
a first vacuum assembly having at least one opening that is capable of applying a first vacuum to corresponding dies to remove the corresponding dies from a first surface of a support element;
a second vacuum assembly configured to apply a second vacuum to a second surface of the support element outside an area;
at least one force element configured to apply a force to the second surface inside the area, wherein the at least one force element is capable of moving the corresponding dies toward the first vacuum assembly.

23. The apparatus of claim 22, wherein the area is defined by a perimeter of the corresponding dies.

24. The apparatus of claim 22, further comprising:
an actuator to actuate the at least one force element, wherein the actuator is configured to cause the at least one force element to come into contact with the area of the second surface.

25. The apparatus of claim 24, wherein the actuator is configured to actuate the at least one force element a predetermined distance.

26. The apparatus of claim 22, wherein the second vacuum assembly is configured to maintain dies that are outside the area in a substantially planar configuration.

27. The apparatus of claim 22, wherein the at least one force element is configured to partially peel the corresponding dies from the first surface.

28. The apparatus of claim 22, wherein the at least one force element comprises a pin, a bar, or a blade.

29. The apparatus of claim 22, wherein the corresponding dies are arranged in a row.

30. An apparatus for removing a plurality of dies from an array of dies that are attached to a first surface of a support element, the support element having a second surface that opposes the first surface, comprising:
means for applying a first vacuum to the second surface outside an area corresponding to a perimeter of the plurality of dies;
means for applying a force to the second surface inside the area, wherein the means for applying the force is configured to move the plurality of dies with respect to other dies of the array of dies; and
means for applying a second vacuum to the plurality of dies to remove the plurality of dies from the first surface.

31. The apparatus of claim 30, wherein the area corresponds to a perimeter of the plurality of dies.

32. The apparatus of claim 30, wherein the means for applying the force includes means for actuating at least one force element associated with the plurality of dies, wherein the means for actuating is configured to cause the at least one force element to come into contact with the area of the second surface to move the dies.

33. The apparatus of claim 30, wherein the means for applying the force is configured to move the plurality of dies a predetermined distance.

34. The apparatus of claim 30, wherein the means for applying the first vacuum is configured to maintain dies of the array of dies that are outside the area in a substantially planar configuration.

35. The apparatus of claim 30, wherein the means for applying the force causes at least partial peeling of the plurality of dies from the first surface when the force is applied.

36. The apparatus of claim 30, wherein the plurality of dies is a row of dies.

37. The apparatus of claim 30, further comprising:
at least one force element configured to be applied by the force applying means.

38. The apparatus of claim 37, wherein the at least one force element comprises a pin, a bar, or a blade.
